(19) United States
(12) Patent Application Publication
(10) Pub. No.: US 2006/0108083 A1
(43) Pub. Date: May 25, 2006

(54) Process and device to disperge a recycled fibre pulp

(76) Inventors: Helmuth Gabl, Graz (AT); Andreas Gorton-Hulgerth, Graz (AT)

Correspondence Address: ALIX YALE & RISTAS LLP, 750 MAIN STREET, SUITE 1400, HARTFORD, CT, 06103, US

(21) Appl. No.: 10/400,612

(22) Filed: Mar. 27, 2003

(30) Foreign Application Priority Data
Mar. 27, 2002 (AU) A 480/2002

(51) Int. Cl. D21C 9/00; D21C 1/02; D21F 1/66; B02C 21/00; D21D 1/00

(52) U.S. Cl. 162/261; 162/56; 162/68; 162/189; 241/21

(57) ABSTRACT

The invention relates to a process for disperging a recycled fibre pulp, where a pre-dewatered pulp is heated, conveyed, and disperged in a disperger. It is mainly characterised the recycled fibre pulp being heated immediately before entering the disperging zone. In addition, the invention refers to a device for implementing the process.

### BACKGROUND OF THE INVENTION

The invention relates to a process to disperge a recycled fibre pulp, where a pre-dewatered pulp is heated, conveyed, and disperged in a disperger. It also refers to a device for implementing the process.

A process and a device of this type are known, e.g. from NO 302 186 B1. Here, the recycled fibre pulp from a dewatering screw is fed to a heating screw, from where the heated pulp is brought into the plug feeder for a disperger. The pulp is then disperged in the disperger. The particular disadvantage here is the amount of equipment needed and the space required for this type of plant. Further processes and devices of this type are known, for example, from DE 199 54 246 A1. On the one hand, the plant described is similar to NO 302 186 B1, and on the other, it also includes the option of feeding in steam directly between the refiner plates of the disperger. The disadvantage of the latter method is that the possible retention time is very short and thus, cannot provide full and even heating.

### SUMMARY OF THE INVENTION

The aim of the invention is thus to provide a process with which to guarantee good and even heating using a small amount of equipment and also where additional chemicals can be added before disperging if necessary.

The invention is thus characterised by the recycled fibre pulp being heated immediately before entering the disperging zone. As a result, an additional unit, such as a heating screw, can be omitted, while still guaranteeing thorough warming of all particles. Thus, the disperging zone can be fed well-heated recycled fibre pulp.

If, according to an advantageous feature of the invention, the recycled fibre pulp is mixed thoroughly while it is being heated, this will provide even warming.

If the recycled fibre pulp is heated by steam and if a vacuum is applied at the conveying unit at the same time, the steam can be well targeted and heat transfer to the recycled fibre pulp optimised.

It is also an advantage to remove the cooled excess steam after it has flowed through the recycled fibre pulp.

In many applications it can also be an advantage to mix chemicals into the recycled fibre pulp. By heating and adding chemicals at the same time, a uniform reaction can be obtained.

In addition, the invention relates to a device for disperging a recycled fibre pulp, comprising a feed unit for steam, a conveying unit, and a disperger. It is characterised by the conveying unit having at least one connection piece or inlet openings for steam. This can be used to heat the recycled fibre pulp shortly before it reaches the disperger, thus dispensing with the need for an additional heating unit.

If the conveying unit is designed as a mixing screw, according to the invention, this will provide even mixing with the steam and thus, even heating.

If, according to a further feature of the invention, at least one connection piece is designed as a vacuum connection, this will achieve targeted steam flow control and optimum heat transfer.

If the connection pieces are mounted at the housing of the conveying unit, a mixing screw for example, this will provide a good heating effect.

A particularly advantageous further development of the invention is characterised by the conveying unit, for example a mixing screw, having a hollow shaft, where the hollow shaft can have spikes for mixing purposes. With this arrangement the steam supply is integral with the shaft and can be directed along the conveying path, which will lead to more even distribution and thus, more even heating.

If the inlet openings of the spikes are mounted at different radii on the conveying unit, for example a mixing screw, steam and/or chemicals can be fed in evenly, also over the cross-section of the conveying screw.

### BRIEF DESCRIPTION OF THE DRAWINGS

The invention will now be described using the examples shown in the drawings, where:

FIG. 1 shows a state-of-the-art plant;

FIG. 2 shows a horizontal projection of a plant according to the invention;

FIG. 3 is a view of FIG. 2 according to the arrow marked III;

FIG. 4 shows a sectional view of a device according to the invention;

FIG. 5 is a schematic view of a variant of the invention;

FIG. 6 shows a special configuration of the invention; and

FIG. 7 is a sectional view of FIG. 4 with another variant of the invention.

### DESCRIPTION OF THE PREFERRED EMBODIMENT

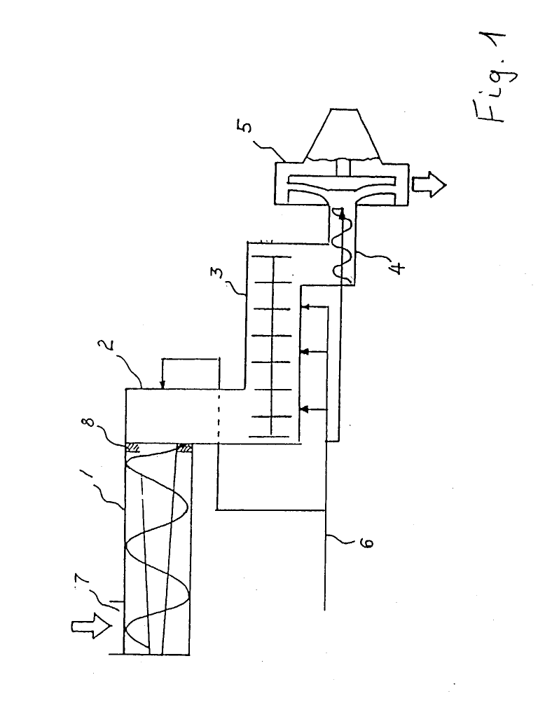

FIG. 1 shows a state-of-the-art plant, where a screw press 1 is provided to dewater the recycled fibre suspension. The dewatered suspension is then fed at a consistency of approximately 20-35%, preferably 25-30%, through a chute 2 to a heating device 3 with rotating blades. Subsequently, the heated suspension drops into an endless screw 4 for feeding to the disperger 5. The steam is fed to the heating device 3 through a steam pipe 6, with some of this steam also being fed in beforehand in the chute 2. The suspension to be treated is supplied to the screw press 1 through an inlet branch 7 and leaves it at the end in plug form 8. The plug 8 at the end of the screw press 1 acts here as a vapour trap or barrier.

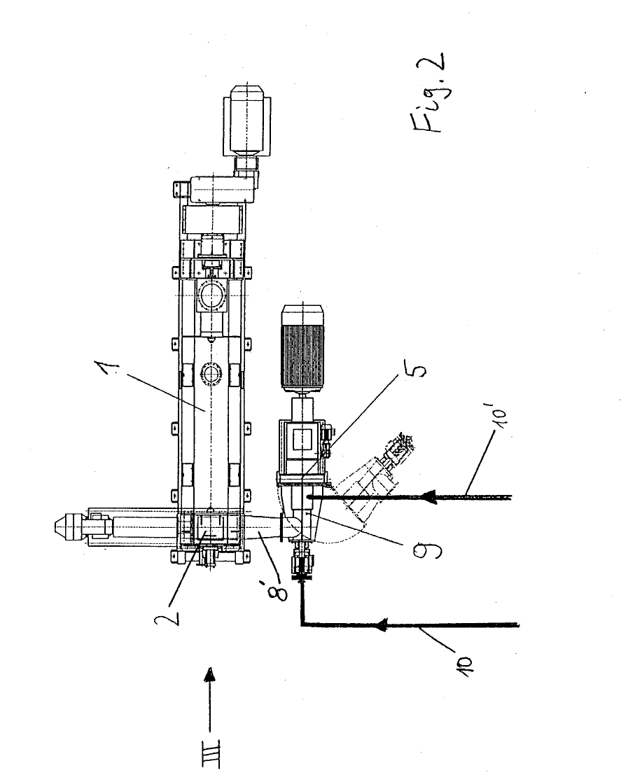

FIG. 2 shows a horizontal projection of a plant according to the invention. Here, the recycled fibre suspension to be treated is also dewatered in a screw press 1 and fed through a chute 2 to a plug screw 8′ and/or then to a conveying unit 9, which can be designed as a feed screw, to a disperger 5. In addition, pipework 10, 10′ is shown here through which steam and chemicals, respectively, are fed to the recycled fibre pulp. The chemicals that may be added are either liquid or gaseous bleaching and hygiene chemicals, such as peroxide, caustic soda, chlorine, ozone, or disperging agent.

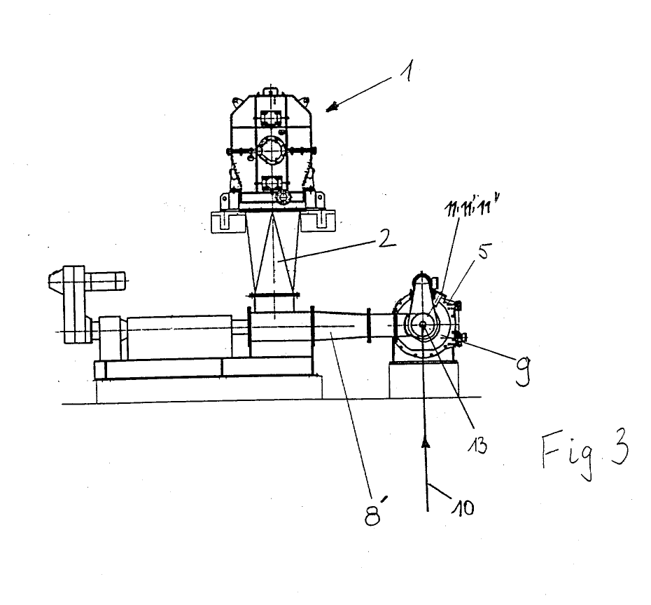

FIG. 3 is a view of FIG. 2 according to the arrow marked III. The screw press 1 is linked to the plug screw 8′ via a chute 2. The recycled fibre suspension is then brought to the conveying unit 9, particularly a feed screw, where the plug screw 8′ also acts as a vapour trap for the steam fed in through the pipe 10. The disperger 5 is then located behind the feed screw.

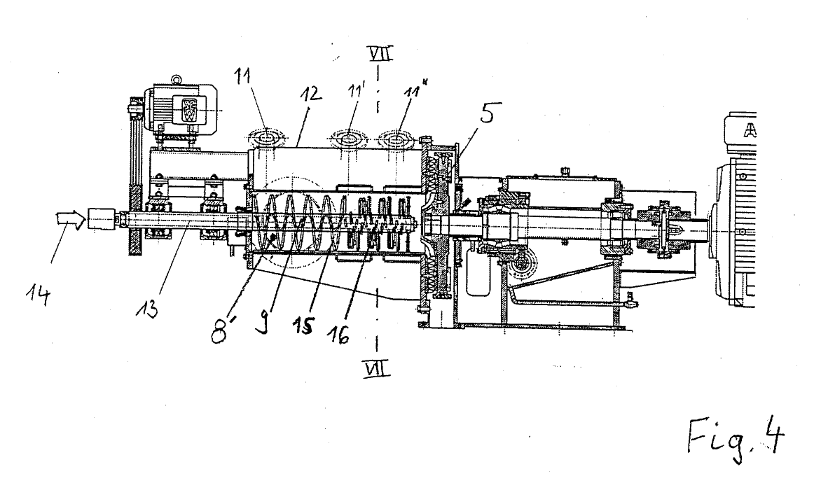

FIG. 4 contains a sectional view through a device according to the invention. The illustration shows where the plug screw 8′ joins the feed section 9 of the endless screw. To supply the steam, connection pieces 11 can be provided at the casing 12 at the beginning of the endless screw or connection pieces 11′ or 11″ at the end section of the endless screw. As an alternative, chemicals can be fed in through these connection pieces. If the conveying unit, particularly a feed screw, is designed with a hollow shaft 13, steam and/or chemicals can also be fed in direction 14 through the hollow shaft. It is a particular advantage if spikes 16 are provided between the screw flights 15. With this arrangement, the steam can also be fed in easily, distributed evenly over the cross-section of the endless screw.

If the steam is fed in through the connection pieces 11, 11′ or 11″, a vacuum (in the opposite direction to 14) can be applied to the hollow shaft 13. As an alternative, steam can be fed in through the hollow shaft 13 and preferably extracted by suction through connection pieces 11. In this case, chemicals can be added through the connection pieces 11′ and/or 11″. The suspension is then fed to the disperger after being heated thoroughly and mixed well.

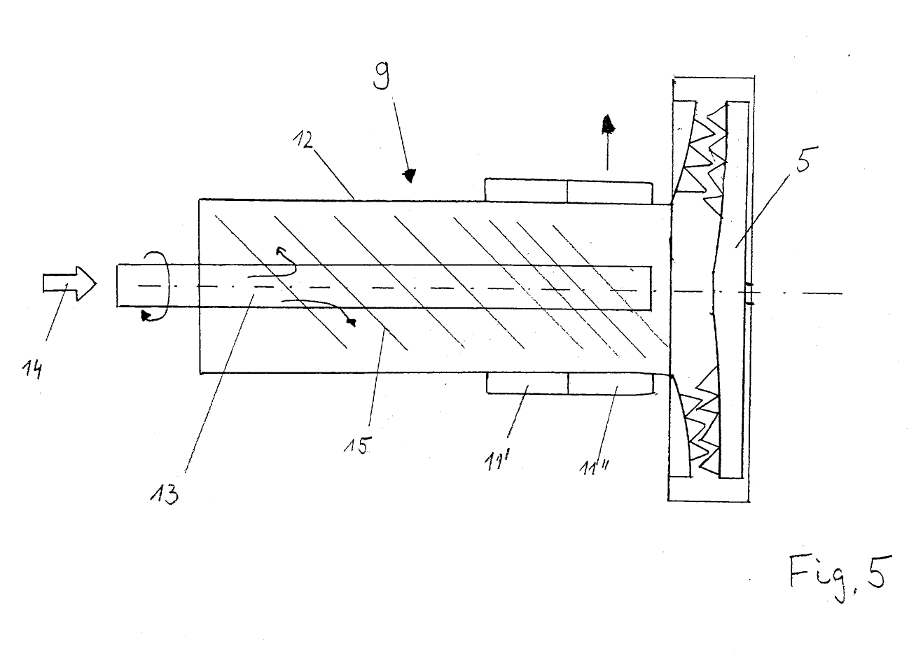

FIG. 5 shows a schematic view of a device according to the invention, where steam is added in direction 14 through the hollow shaft 13. The steam is discharged evenly at different points over the length of the shaft. The recycled fibre suspension has a temperature of approximately 20° C. up to 80° C. here, usually 40-60° C. The excess steam is then extracted by suction through the connection pieces 11, 11′ and 11″. The connection pieces 11, 11′ and 11″ can be designed as channels on the screw casing 12, fully or partly around the circumference. Immediately before entering the disperging zone, e.g., between the relatively rotating plates (where the contaminants are removed from the recycled fibre suspension and/or intimate chemical mixing is completed), the temperature of the suspension rises beyond 85° C. This immediacy is optimized because the heating is performed in the feed device 9 for the disperger plates 5, which is coaxially rotated adjacent to the plates.

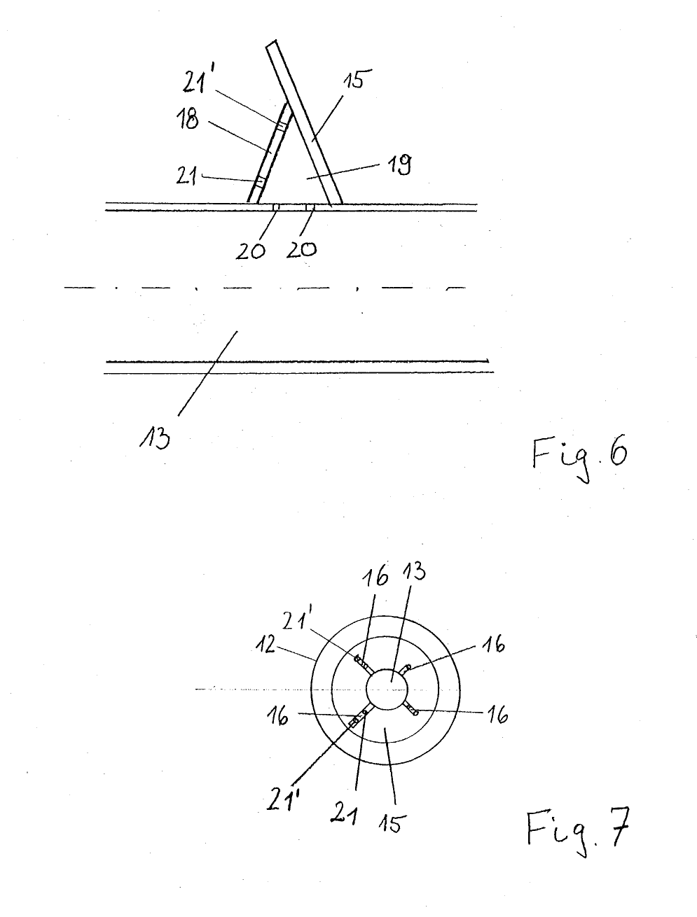

FIG. 6 illustrates a means of supplying the steam. The screw flight 15 mounted on the hollow shaft 13 is supported by a wall 18 in such a way as to form a cavity 19. The steam flows out of the hollow shaft 13 through holes 20 into the cavity 19 and is then fed to the recycled fibre suspension through inlet openings 21, 21′. Depending on the position of the inlet openings 21, 21′, the steam can be fed to the suspension at different points in the cross-section of the conveying unit 9, particularly a feed screw.

FIG. 7 corresponds to a section through the line marked VII-VII in FIG. 4. The hollow shaft 13 running inside the screw casing 12 has several heating spikes 16 which can be of different lengths. For steam feed to the suspension the spikes 16 have inlet openings 21, 21′, which guarantee distribution over the cross-section of the conveying unit 9. The spikes 16 can also be open at the top end (pointing away from the shaft).

1. In a process for disperging a recycled fibre pulp by introducing a heated recycled fibre pulp slurry into a disperging zone between relatively rotating disperger plates, the improvement comprising heating the slurry immediately upstream of the disperging zone.

2. Process according to claim 1, wherein the recycled fibre pulp is mixed thoroughly while it is being heated.

3. Process according to claim 1 wherein the recycled fibre pulp is heated by steam.

4. Process according claim 3, wherein a vacuum is applied to draw cooled excess steam away from the fibre pulp after heating the pulp.

5. Process according to claim 4, wherein the cooled excess steam is removed after it has flowed through the recycled fibre pulp.

6. Process according to claim 1, wherein chemicals are mixed into the recycled fibre pulp while it is being heated.

7. Process according to claim 1, wherein the pulp slurry is heated while conveyed to the disperger zone in a direction generally coaxial with the plate rotation axis.

8. Apparatus for disperging a recycled fibre pulp, comprising:
a disperger having a disperger zone in which a recycled fibre pulp slurry is passed between relatively rotating plates;
a conveyor for feeding the slurry into the disperger; and
means for supplying steam to the slurry in the conveyor.

9. Apparatus according to claim 8, wherein the conveyor is a mixing screw.

10. Apparatus according to claim 8, including means for exposing the heated slurry in the conveyor, to a vacuum.

11. Apparatus according claim 8, wherein the conveyor includes a housing and the means for supplying steam includes fluid connections mounted at the housing.

12. Apparatus according to claim 8, wherein the conveyor is a mixing screw, having a hollow shaft through which said steam is supplied to the slurry.

13. Apparatus according to claim 12, wherein the hollow shaft has spikes for mixing the slurry.

14. Apparatus according to claim 12, wherein steam inlet openings in fluid communication with the hollow shaft are located at different radii on the mixing screw.

15. Apparatus according to claim 9, including means for introducing chemicals into the slurry in the conveyor.

16. In a fibre pulp disperging unit comprising a disperger and an adjacent feeder for delivering the pulp to the disperger, the improvement comprising a steam inlet into the feeder.

17. The disperging unit of claim 16, wherein the feeder is a screw conveyor disposed in a housing, and the steam inlet is a conduit at the housing.

18. The disperging unit of claim 16, wherein the feeder is a screw conveyor disposed in a housing, and the steam inlet includes channels in the housing.

19. The disperging unit of claim 16, wherein the feeder is a screw conveyor having a hollow shaft and the steam inlet is integral with the shaft.
